(19) United States
(12) Patent Application Publication
(10) Pub. No.: US 2002/0119902 A1
(43) Pub. Date: Aug. 29, 2002

(54) Low residue aqueous hard surface cleaning compositions particularly adapted for cleaning glass and glossy hard surfaces

(75) Inventors: Kenneth Allen Harrison, Goshen, NY (US); Jeanne Marie Weller, Glen Rock, NJ (US); Ann Marie Lynch, Glen Rock, NJ (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Reckitt Benckiser Inc.

(21) Appl. No.: 09/990,062

(22) Filed: Nov. 21, 2001

Related U.S. Application Data
(63) Continuation of application No. PCT/GB00/01859, filed on May 19, 2000.

(30) Foreign Application Priority Data
May 21, 1999 (GB) 9911818.4

(51) Int. Cl. C11D 17/00

(52) U.S. Cl. 510/424; 510/428; 510/470

(57) ABSTRACT

Aqueous based cleaning compositions simultaneously featuring disinfecting, low residue deposits and good cleaning characteristics are provided, which are particularly useful for cleaning glass and polished hard surfaces. The compositions include (a) at least one anionic a linear C₆-C₁₈ alkyl sulfate surfactant; (b) at least one surfactant based on a glycoside; (c) a solvent system containing an alkylene glycol ether solvent, further with a C₁-C₆ alcohol; and (d) water.

### CROSS-REFERENCE TO RELATED APPLICATIONS

This application is a continuation of International Application No. PCT/GBOO/01859, filed May 19, 2000, which was published in the English language on Nov. 30, 2000 under International Publication No. WO 00/71661 A1 and the disclosure of which is incorporated herein by reference.

### BACKGROUND OF THE INVENTION

Cleaning compositions are commercially important products and enjoy a wide field of utility in assisting in the removal of dirt and grime from surfaces, especially glass and glossy hard surfaces (i.e., glazed ceramic tiles, polished metals, enameled metal surfaces, glazed porcelain). While the art is replete with various formulations which provide some cleaning benefit and perhaps some disinfecting benefit to surfaces, there is a real and continuing need for such further formulations.

### BRIEF SUMMARY OF THE INVENTION

Thus, it is among the objects of the invention to provide improved aqueous cleaning compositions which are especially useful in cleaning, especially hard surfaces particularly glass and other glossy hard surfaces. Such a composition is particularly useful for use “as-is” by the ultimate user. It is a further object of the invention to provide a process for cleaning hard surfaces, which process comprises the step of: providing an aqueous cleaning composition as outlined herein, and applying an effective amount of the same to a surface, especially a hard surface requiring such cleaning treatment.

According to one aspect of the present invention there is provided an aqueous cleaning composition which provides disinfecting and cleaning characteristics to treated surfaces, particularly hard surfaces, which comprises the following constituents:

(A) at least one anionic a linear C₆-C₁₈ alkyl sulfate surfactant, preferably predominantly a linear lauryl sulfate;

(B) at least one surfactant based on a glycoside;

(C) a solvent system containing an alkylene glycol ether solvent, especially propylene glycol n-butyl ether, ethylene glycol hexyl ether, further with a C₁-C₆ alcohol, especially where the C₁-C₆ alcohol is isopropanol; and

(D) water.

The compositions may include one or more further optional additive constituents, sometimes referred to as adjuvants, in minor, but effective amounts. By way of non-limiting example, such optional additives include: coloring agents such as dyes and pigments, fragrances, other pH adjusting agents, pH buffer compositions, chelating agents, rheology modification agents as well as one or more further surfactant compounds, in particular nonionic, amphoteric or zwitterionic surfactant compounds. Desirably, in order to reduce the likelihood of undesired buildup upon treated surfaces, especially hard surfaces, the amounts of these additive constituents are present in only minor amounts, i.e., less than 10%, preferable less than 5% wt. based on the total weight of the aqueous cleaning composition being provided herein.

### DETAILED DESCRIPTION OF THE INVENTION

The inventive compositions include (A) at least one anionic a linear C₆-C₁₈ alkyl sulfate surfactant. Such materials are commercially available as anionic surfactants and are frequently provided in a salt form in an aqueous carrier. Typically such salt forms include counterions based on alkali or alkaline earth metals. It is known that such sulfate surfactants may be provided as a technical grade mixture, which may include sulfates which include various C₆-C₁₈ alkyl chains. According to the present invention it is preferred that a preponderance of alkyl groups be C₁₂ groups, viz., be linear C₁₂ alkyl sulfates. Still more preferably they consist of at least 70%, more preferably at least 85%, still more preferably comprise at least 95% of the linear alkyl groups be C₁₂ alkyl groups. Such materials are commercially available, inter alia, under the trade name Sulfotex® WAQ-LCX (ex. Henkel Corp.) of which various technical grade aqueous mixtures are presently commercially available.

The linear C₆-C₁₈ alkyl sulfate surfactants comprise 0-10% wt., yet more preferably 0.01-5% wt. but most preferably comprise 0.01-3% wt. of the compositions of which they form a part.

The compositions according to the present invention also include (B) at least one surfactant based on a glycoside. Exemplary suitable compounds include alkyl monoglycosides and polyglycosides are prepared generally by reacting a monosaccharide, or a compound hydrolyzable to a monosaccharide with an alcohol such as a fatty alcohol in an acid medium.

Exemplary alkyl glycoside surfactants suitable for use in the practice of this invention may be represented by formula I below:

RO—(R₁O)_{y}—(G)ₓZ_{b} (I)

wherein:

R is a monovalent organic radical containing from about 6 to about 30, preferably from about 8 to about 18 carbon atoms;

R1 is a divalent hydrocarbon radical containing from about 2 to about 4 carbon atoms, especially ethyl and propyl radicals;

O is an oxygen atom;

y is a number which has an average value from about 0 to about 1 and is preferably 0;

G is a moiety derived from a reducing saccharide containing 5 or 6 carbon atoms;

x is a number having an average value from about 1 to 5 (preferably from 1.1 to 2);

Z is selected from O₂M¹,

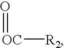

O(CH₂), CO₂M¹, OSO₃M¹, or O(CH₂)SO₃M¹; R₂ is (CH₂)CO₂M¹ or CH═CHCO₂M¹;

with the proviso that Z can be O₂M¹ only if Z is in place of a primary hydroxyl group in which the primary hydroxyl-bearing carbon atom, —CH₂OH, is oxidized to form a

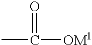

group);

b is a number of from 0 to 3x+1 preferably an average of from 0.5 to 2 per glycosyl group; and

M¹ is H⁺ or an organic or inorganic cation, for example an alkali metal, ammonium, monoethanolamine, or calcium.

As defined in Formula I above, R is generally the residue of a fatty alcohol having from about 8 to 30 and preferably 8 to 18 carbon atoms.

Most preferably, the inventive compositions include an alkylpolyglycoside compound according to the structure:

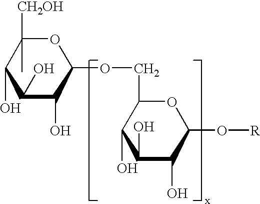

wherein:

R is an alkyl group, preferably a linear alkyl chain, which comprises C₈ to C₁₆ alkyl groups; and

x is an integer value of from 0-3, inclusive.

Examples of such alkylpolyglycoside compounds according to this structure include: where R is comprised substantially of C₈ and C₁₀ alkyl chains yielding an average value of about 9.1 alkyl carbons per molecule (GLUCOPON 220 UP, GLUCOPON 225 DK); where R is comprised of C₈, C₁₀, C₁₂, C₁₄ and C₁₆ alkyl carbons yielding an average value of about 10.3 alkyl carbons per molecule (GLUCOPON 425); where R is comprised substantially of C₁₂, C₁₄ and C₁₆ alkyl carbons yielding an average value of about 12.8 alkyl carbons per molecule (GLUCOPON 600 UP, GLUCOPON 625 CSUP, and GLUCOPON 625 FE), all of which are available from Henkel Corp., Ambler, Pa.) Also useful as the alkylpolyglycoside compound is TRITON CG-110 (Union Carbide Corp.).

Further examples of commercially available alkylglycosides as described above include, for example, GLUCOPON 325N which is described as being a 50% C₉-C₁₁ alkyl polyglycoside, also commonly referred to as D-glucopyranoside (from Henkel Corp, Ambler, Pa.). Particularly preferred as the alkylpolyglycoside compounds are those illustrated in the Examples. These alkylpolyglycosides may be present in any amount. It will be understood that this such a minimum amount will vary widely, and is in part dependent upon the molecular weight of the alkylpolyglycoside utilized in a formulation, but desirably at least about 0.01% wt. should be present. More preferably the polyglycoside comprises from 0.02% wt. to 10% wt. of the compositions of which it forms a part. Further and particularly preferred examples of alkylpolyglycosides are described with reference to the Examples.

The compositions of the invention include a solvent system (C) containing an alkylene glycol ether solvent, further with a C₁-C₆ alcohol, especially where the C₁-C₆ alcohol is isopropanol. Particularly useful alkylene glycol ethers include C₃-C₂₀ glycol ethers. Specific illustrative examples of useful alkylene glycol ether solvents include: propylene glycol methyl ether, dipropylene glycol methyl ether, tripropylene glycol methyl ether, propylene glycol isobutyl ether, ethylene glycol methyl ether, ethylene glycol ethyl ether, ethylene glycol butyl ether, diethylene glycol phenyl ether, propylene glycol phenol ether, and mixtures thereof. More preferably employed as the solvent is one or more of the group consisting of ethylene glycol n-butyl ether, diethylene glycol n-butyl ether, and mixtures thereof. Preferably, the solvent system (C) includes both propylene glycol n-butyl ether with ethylene glycol hexyl ether, and in certain especially preferred embodiments propylene glycol n-butyl ether and ethylene glycol hexyl ether are the sole glycol ethers of the solvent system(C). Propylene glycol n-butyl ether is known to the art. It is commercially available as Dowanol® PnB (ex. Dow Chem. Co., Midland, Mich.). The propylene glycol n-butyl ether may be present in amounts of from 0.01% wt.-6.0 wt., however is advantageously present in amounts of from 0.01 4% wt. Ethylene glycol hexyl ether is also, per se, known to the art. It is commercially available as Hexyl Cellosolve® (ex. Union Carbide Corp.). The ethylene glycol hexyl ether may be present in amounts of from 0.01% wt.-5.0% wt., however is advantageously present in amounts of from 0.01-2% wt.

The inventors have observed that the compositions according to the present invention exhibit desirable evaporation and drying properties (e.g., relatively uniform drying with no streaking, no mottling). Certain particularly preferred embodiments of the inventive compositions form a substantially uniform film during evaporative drying subsequent to application on a hard surface.

The compositions of the invention also include a C₁-C₆ alcohol as part of the (C) solvent system. Such include for example methanol, ethanol, n-propanol, isopropanol as well as the various positional isomers of butanol, pentanol and hexanol. The inclusion of such alcohols have been found by the present inventor to even further improve in the evaporation of the inventive composition in a relatively even manner such that it tends to form a relatively uniform film layer during the drying process. This effect has been generally described above in conjunction with glycol n-butyl ether and ethylene glycol hexyl ether. A further benefit of the inclusion of such alcohols is in the solvency which they may provide to certain stains as well. Of these, the inclusion of isopropanol is most preferred. The C₁-C₆ alcohol may be present in amounts of from 0.01% wt.-10% wt., however is advantageously present in amounts of from 0.01-60% wt.

According to certain particularly preferred embodiments, the solvent system (C) consists solely of propylene glycol n-butyl ether, ethylene glycol hexyl ether and isopropanol to the exclusion of other C₁-C₆ alcohols and other glycol ethers.

As is noted above, the compositions according to the invention are aqueous in nature, and include (D) as a further essential constituent. Water is added in order to provide to 100% by weight of the compositions of the invention, and is preferably deionized water.

Certain preferred embodiments of compositions according to the invention may be categorized as “non-food contact surface sanitizing” compositions as they exhibit antimicrobial efficacy against at least Staphylococcus aureus, Salmonella cholerasuis, and Enterobacter aerogenes in accordance with the “ASTM Standard Test Method for Efficacy of Sanitizers Recommended for Inanimate Non-Food Contact Surfaces” (E 1153-87), or broad spectrum disinfecting efficacy against at least Staphylococcus aureus, or Salmonella cholerasuis (preferably against both) by the “AOAC Official Method 961.02 Germicidal Spray Products as Disinfectants” (per AOAC Official Methods of Analysis, 16^{th} Edition (1995)). Both of these tests are known to those skilled in the art.

As noted, the compositions may include one or more optional additives which by way of non-limiting example include: coloring agents such as dyes and pigments, fragrances and fragrance solubilizers, pH adjusting agents, pH buffering agents, chelating agents, rheology modification agents, as well as one or more further nonionic surfactant compounds. Desirably, in order to reduce the likelihood of undesired buildup upon treated surfaces, especially hard surfaces, the total amounts of such optional additives is less than about 10% wt. but are desirably significantly less, such as less than about 2.5% wt. based on the total weight of the aqueous cleaning and disinfecting composition being provided herein. Optimally, the amounts of such further optional additives is kept to a minimum in order to minimize the amounts of non-volatile constituents in the compositions as a whole, which tend to contribute to an undesired streaky or mottled appearance of the composition during drying.

Useful as chelating agents include those known to the art, including by way of non-limiting example; aminopolycarboxylic acids and salts thereof wherein the amino nitrogen has attached thereto two or more substituent groups. Preferred chelating agents include acids and salts, especially the sodium and potassium salts of ethylenediaminetetraacetic acid, diethylenetriaminepentaacetic acid, N-hydroxyethylethylenediaminetriacetic acid, and of which the sodium salts of ethylenediaminetetraacetic acid may be particularly advantageously used. Such chelating agents may be omitted, or they may be included in generally minor amounts such as from 0-0.5% wt. based on the weight of the chelating agents and/or salt forms thereof. Desirably, such chelating agents are included in the present inventive composition in amounts from 0-0.5% wt., but are most desirably present in reduced weight percentages from about 0-0.2% wt.

The compositions according to the invention optionally but desirably include an amount of a pH adjusting agent or pH buffer composition. Such compositions include many which are known to the art and which are conventionally used. By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, bicarbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. These may be included in any effective amount which may be used to adjust and maintain the pH of the compositions of the invention to the desired pH range, which is usually in the range of from about 4-12. These should be screened however to ensure that they do not undesirably deposit residues upon the surfaces being treated. Particularly useful are sodium hydroxide, and sodium bicarbonate, which are present in certain particularly preferred embodiments of the invention.

Further optional, but advantageously included constituents are one or more coloring agents, which find use in modifying the appearance of the compositions and enhance their appearance from the perspective of a consumer or other end user. Known coloring agents may be incorporated in the compositions in any effective amount to improve or impart to compositions a desired appearance or color. Such a coloring agent or coloring agents may be added in a conventional fashion, i.e., admixing to a composition or blending with other constituents used to form a composition.

Further optional, but desirable constituents include fragrances, natural or synthetically produced. Such fragrances may be added in any conventional manner, admixing to a composition or blending with other constituents used to form a composition, in amounts which are found to be useful to enhance or impart the desired scent characteristic to the composition, and/or to cleaning compositions formed therefrom. In addition to a fragrance, it is frequently desirable to include a fragrance solubilizer which assists in the dispersion, solution or mixing of the fragrance constituent in an aqueous base. These include known art compounds, including condensates of 2 to 30 moles of ethylene oxide with sorbitan mono- and tri-C₁₀-C₂₀ alkanoic acid known to be useful as nonionic surfactants. Further examples of such suitable surfactants include water soluble nonionic surfactants of which many are commercially known and by way of non-limiting example include the primary aliphatic alcohol ethoxylates, secondary aliphatic alcohol ethoxylates, alkylphenol ethoxylates and ethylene-oxide-propylene oxide condensates on primary alkanols, and condensates of ethylene oxide with sorbitan fatty acid esters. This fragrance solubilizer component is added in minor amounts, particularly amount which are found effective in aiding in the solubilization of the fragrance component, but not in any significantly greater proportion, such that it would be considered as a detergent constituent. Such minor amounts recited herein are generally up to about 0.3% by weight of the total composition but is more generally an amount of about 0.1% by weight and less, and preferably is present in amounts of about 0.05% by weight and less.

As an optional constituent, the compositions may include one or more nonionic surfactant compounds in amounts which are effective in improving the overall cleaning efficacy of the compositions being taught herein, while at the same time in amounts which do not undesirably diminish the germicidal efficacy of the inventive compositions or which undesirably increase the likelihood to form or deposit surface residues onto the treated surfaces. Such nonionic surfactant compounds are known to the art. Practically any hydrophobic compound having a carboxy, hydroxy, amido, or amino group with a free hydrogen attached to the nitrogen can be condensed with ethylene oxide or with the polyhydration product thereof, polyethylene glycol, to form a water soluble nonionic surfactant compound. Further, the length of the polyethylenoxy hydrophobic and hydrophilic elements may be varied. Exemplary nonionic compounds include the polyoxyethylene ethers of alkyl aromatic hydroxy compounds, e.g., alkylated polyoxyethylene phenols, polyoxyethylene ethers of long chain aliphatic alcohols, the polyoxyethylene ethers of hydrophobic propylene oxide polymers, and the higher alkyl amine oxides.

To be mentioned as particularly useful nonionic surfactants are alkoxylated linear primary and secondary alcohols such as those commercially available under the tradenames PolyTergent® SL series (Olin Chemical Co., Stamford Conn.), Neodolo® series (Shell Chemical Co., Houston Tex.); as alkoxylated alkyl phenols including those commercially available under the tradename Triton® X series (Union Carbide Chem. Co., Danbury Conn.).

Further useful optional surfactants include amine oxides, such as lauryl dimethyl amine oxides, betaines and sarcosinate based surfactants.

Such constituents as described above as essential and/or optional constituents include known art compositions, include those described in McCutcheon's Emulsifiers and Detergents (Vol.1), McCutcheon's Functional Materials (Vol. 2), North American Edition, 1991; Kirk-Othmer, Encyclopedia of Chemical Technology, 3rd Ed., Vol. 22, pp. 346-387, the contents of which are herein incorporated by reference.

According to one particularly preferred aspect of the present invention there is provided an aqueous cleaning composition which provides both disinfecting and cleaning characteristics to treated surfaces, particularly hard surfaces, which comprises the following constituents:

(A) 0.01-10% wt. of at least one anionic a linear C₆-C₁₈ alkyl sulfate surfactant, preferably predominantly a linear lauryl sulfate;

(B) 0.01-10% wt. of at least one surfactant based on a glycoside;

(C) a solvent system containing: 0.01-11% wt. of one or more alkylene glycol ether solvents, (especially 0.01-6.0% wt. propylene glycol n-butyl ether, 0.1-5% wt. ethylene glycol hexyl ether) with 0.1-10% wt. of a C₁-C₆ alcohol, especially where the C₁-C₆ alcohol is isopropanol; and

(D) to 100% wt. water;

and further, 0.01-2% wt. of a pH buffer or pH adjusting agent, especially one or more hydroxides, carbonates or bicarbonates, and further 0-10% wt. of optional additives as described herein.

The compositions of the invention can be prepared in a conventional manner such as by simply mixing the constituents in order to form the ultimate aqueous cleaning composition. The order of addition is not critical.

The compositions according to the invention are useful in the cleaning and/or sanitizing of surfaces, especially hard surfaces, having deposited soil thereon. The compositions are particularly effective in the removal of oleophilic soils (viz., oily soils) particularly of the type which are typically encountered in kitchens and other food preparation environments. In such a process, cleaning and disinfecting of such surfaces comprises the step of applying a soil releasing and disinfecting effective amount of a composition as taught herein to such a soiled surface. Afterwards, the compositions are optionally but desirably wiped, scrubbed or otherwise physically contacted with the hard surface, and further optionally, may be subsequently rinsed from such a cleaned and disinfected hard surface.

The hard surface cleaner composition provided according to the invention can be desirably provided as a ready to use product in a manually operated spray dispensing container and is thus ideally suited for use in a consumer “spray and wipe” application. In such an application, the consumer generally applies an effective amount of the cleaning composition using the pump and within a few moments thereafter, wipes off the treated area with a rag, towel, or sponge, usually a disposable paper towel or sponge. To ensure effective sanitization or disinfection, a longer contact time, generally of 10 minutes is required.

In a yet a further embodiment, the compositions according to the invention may be formulated so that they may be useful in conjunction with an “aerosol” type product wherein they are discharged from a pressurized aerosol container. If the inventive compositions are used in an aerosol type product, it is preferred that corrosion resistant aerosol containers such as coated or lined aerosol containers be used. Such are preferred as they are known to be resistant to the effects of acidic formulations. Known art propellants such as liquid propellants as well as propellants of the non-liquid form, i.e., pressurized gases, including carbon dioxide, air, nitrogen, hydrocarbons as well as others may be used. Also, while satisfactory for use, fluorocarbons may be used as a propellant but for environmental and regulatory reasons their use is preferably avoided.

Whereas the present invention is intended to be produced and provided in the “ready-to-use” form described above, nothing in this specification shall be understood as to limit the use of the composition according to the invention with a further amount of water to form a cleaning solution therefrom. The aqueous compositions according to the invention may be used, and are preferably used “as-is” without further dilution, they may also be used with a further aqueous dilution. Such dilutions include ratios (w %/w %, or v %/v %) of composition:water concentrations of from 1:0, to extremely dilute dilutions such as 1:10,000. Desirably however, in order to ensure disinfection the compositions should be used “as is”, that is to say without further dilution.

The following examples illustrate the superior properties of the formulations of the invention and particular preferred embodiments of the inventive compositions. The terms “parts by weight” or “percentage weight” are used interchangeably in the specification and in the following Examples wherein the weight percentages of each of the individual constituents are indicated in weight percent based on the total weight of the composition of which it forms a part, unless indicated otherwise.

### EXAMPLES:

An exemplary formulation illustrating a preferred embodiment of the inventive compositions and described in more detail in Table 1 below was formulated generally in accordance with the following protocol.

Into a suitably sized vessel, a measured amount of water was provided after which the constituents were added in the following sequence: surfactants, solvents followed by the remaining constituents, including any optional constituents. All of the constituents were supplied at room temperature, and mixing of the constituents was achieved by the use of a mechanical stirrer with a small diameter propeller at the end of its rotating shaft. Mixing, which generally lasted from 5 minutes to 120 minutes was maintained until the particular exemplary formulation appeared to be homogeneous. The exemplary compositions were readily pourable, and retained well-mixed characteristics (i.e., stable mixtures) upon standing. It is to be noted that the constituents might be added in any order, but it is preferred that water be the initial constituent provided to a mixing vessel or apparatus as it is the major constituent and addition of the further constituents thereto is convenient. The exact compositions of the example formulations are listed on Table 1, below wherein are indicated the weight percentages of the individual constituents, based on a total weight of 100% weight.

TABLE 1

| | Ex. 1 |
|---|---|
| Sodium lauryl sulfate | 0.40 |
| alkyl polyglucoside | 0.15 |
| Propylene glycol n-butyl ether | 1.5 |
| Ethylene glycol hexyl ether | 1.0 |
| Isopropanol | 3.5 |
| sodium hydroxide | 0.041 |
| sodium bicarbonate | 0.05 |
| Fragrance | 0.05 |
| di water | to 100 |

The amounts indicated on Table 1 relating to each constituent indicate the “actives weight” of the identified constituent. The specific identity and source of the particular constituents recited in Table 1 are also disclosed in Table 2 below.

TABLE 2

| | |
|---|---|
| sodium lauryl sulfate | Sulfotex ® WAQ-LCX, 30% wt. |
| | actives, from Henkel |
| alkyl polyglucoside | APG 325N, 50% wt. actives, from |
| | Henkel |
| propylene glycol n-butyl ether | Dowanol ® PnB, 100% wt. actives, ex. |
| | Dow Chemical Co. |
| ethylene glycol hexyl ether | Hexyl Cellosolve ®, 100% wt. actives, |
| | ex. Union Carbide Corp. |
| Isopropanol | isopropanol, 100% wt. actives, ex. |
| | Aldrich Chem. Co. |
| sodium hydroxide | anhydrous, 25% wt. actives, ex. |
| | Aldrich Chem. Co. |
| sodium bicarbonate | anhydrous, 100% wt. actives, ex. |
| | Aldrich Chem. Co. |
| Fragrance | proprietary composition |
| di water | deionized water |

The compositions of Table 1 were evaluated in accordance with one or more of the further tests described below.

Evaluation of Antimicrobial Efficacy:

The exemplary formulation described on Table 1 above was evaluated in order to evaluate its antimicrobial efficacy against Staphylococcus aureus (gram positive type pathogenic bacteria) (ATCC 6538), and Enterobacter aerogenes aureus (gram negative type pathogenic bacteria) (ATCC 13048) in accordance with the “ASTM Test Standard Test Method for Efficacy of Sanitizers Recommended for Inanimate Non-Food Contact Surfaces, E 1153-87) As is appreciated by the skilled practitioner in the art, the results of this test indicates log reduction of test organisms which are subjected to a test composition based on Ex. 1. The results of the antimicrobial testing are indicated on Table 3, below.

TABLE 3

| | | |
|---|---|---|
| | | Log₁₀ |
| Formula: | Log₁₀ recovery | reduction |

Enterobacter aerogenes

| | | |
|---|---|---|
| Ex. 1 | 0 | 5.46 |
| Control | 5.46 | n/a |

Staphylococcus aureus

| | | |
|---|---|---|
| Ex. 1 | 0 | 5.89 |
| Control | 5.89 | n/a |

As a control, (“Control” in Table 3) an aqueous composition containing 0.01% wt. of an ethoxylated phenolic surfactant (Triton-X100®, ex. Union Carbide) was also tested. As may be seen from the results indicated above, the compositions according to the invention provide excellent sanitization of hard surfaces, while the compositions based on the ethoxylated phenolic surfactant performed poorly. It is to be noted that a Log10 reduction of 3 or more indicates a passing sanitization score in the test.

The formulation described on Table 1 was also evaluated in order to evaluate its antimicrobial efficacy against two series of 60 test samples of Staphylococcus aureus (gram positive type pathogenic bacteria) (ATCC 6538), and a single series of 30 test organisms of), Salmonella choleraesuis (gram negative type pathogenic bacteria) (ATCC 10708), in accordance with the protocol described within the “AOAC Official Method 961.02 Germicidal Spray Products as Disinfectants” (per AOAC Official Methods of Analysis, 16^{th} Edition (1995)). The results of the antimicrobial testing are indicated on Table 4, below. The reported results indicate the number of test slides with live test organisms/number of test slides at the conclusion of the test for the example formulation and organism tested, as well as the recovery counts.

TABLE 4

| | live test organisms/number of |
|---|---|
| | test slides |
| Ex. 1, Staphylococcus aureus, | 0/60 |
| (1st test) | |
| Ex. 1, Staphylococcus aureus | 0/60 |
| (2nd test) | |
| Ex. 1, Salmonella choleraesuis | 0/30 |

Evaluation of Cleaning Efficacy:

The compositions according the invention are expected to provide good cleaning.

Evaluation of Evaporation and Drying Characteristics:

The compositions of the invention are expected to have good evaporative and satisfactory drying characteristics.

While described in terms of the presently preferred embodiments, it is to be understood that the present disclosure is to be interpreted as by way of illustration, and not by way of limitation, and that various modifications and alterations apparent to one skilled in the art may be made without departing from the scope and spirit of the present invention.

We claim:

1. A low residue aqueous cleaning and disinfecting composition which comprises:
(A) at least one anionic a linear C₆-C₁₈ alkyl sulfate surfactant
(B) at least one surfactant based on a glycoside;
(C) a solvent system containing an alkylene glycol ether solvent, further with a C₁-C₆ alcohol; and
(D) water.

2. The low residue aqueous hard surface cleaning and disinfecting composition according to claim 1, wherein the surfactant (A) is predominantly a linear lauryl sulfate.

3. The low residue aqueous hard surface cleaning and disinfecting composition according to claim 1, wherein the sole alkylene glycol ether solvents are propylene glycol n-butyl ether, and ethylene glycol hexyl ether.

4. The low residue aqueous hard surface cleaning and disinfecting composition according to claim 1, wherein the solvent system consists solely of propylene glycol n-butyl ether, ethylene glycol hexyl ether and a C₁-C₆ alcohol.

5. The low residue aqueous hard surface cleaning and disinfecting composition according to claim 1, wherein the solvent system consists solely of propylene glycol n-butyl ether, ethylene glycol hexyl ether and isopropanol.

6. A composition according to claim 1, further characterized in that the composition forms a substantially uniform film during evaporative drying subsequent to application on a hard surface.

7. A composition according to claim 1, which further comprises a pH adjusting agent or a pH buffering agent.

8. A composition according to claim 1, comprising per 100% wt.:
(A) 0.01-10% wt. of at least one anionic a linear C₆-C₁₈ alkyl sulfate surfactant;
(B) 0.01-10% wt. of at least one surfactant based on a glycoside;
(C) a solvent system containing: 0.01-11% wt. of one or more alkylene glycol ether solvents, and 0.1-10% wt. of a C₁-C₆ alcohol;
(D) to 100% wt. water;
a pH buffer or pH adjusting agent;
and further 0-10% wt. of optional additives as described herein.

9. A composition according to claim 1, comprising per 100% wt.:
(A) 0.01-10% wt. of at least one anionic a linear C₆-C₁₈ alkyl sulfate surfactant;
(B) 0.01-10% wt. of at least one surfactant based on a glycoside;
(C) a solvent system containing: 0.01-6.0% wt. propylene glycol n-butyl ether, 0.1-5% wt. ethylene glycol hexyl ether and 0.1-10% wt. of a C₁-C₆ alcohol;
(D) to 100% wt. water;
a pH buffer or pH adjusting agent;
and further 0-10% wt. of optional additives as described herein.

10. The composition according to claim 8, wherein the compositions are characterized by forming a substantially uniform film during evaporative drying after being applied to a hard surface.

11. The composition according to claim 9, wherein the compositions are characterized by forming a substantially uniform film during evaporative drying after being applied to a hard surface

12. A process for the cleaning and disinfecting of a hard surface in need of such treatment which comprises the step of:
applying an effective amount of the composition according to claim 1.
